(19) United States
(12) Patent Application Publication
(10) Pub. No.: US 2015/0022833 A1
(43) Pub. Date: Jan. 22, 2015

(54) IMAGE FORMING APPARATUS, IMAGE FORMING METHOD, AND RECORDING MEDIUM

(71) Applicant: Sharp Kabushiki Kaisha, Osaka (JP)

(72) Inventors: Yusuke Nagai, Osaka (JP); Hiroyuki Ataka, Osaka (JP); Masaki Higashiura, Osaka (JP)

(21) Appl. No.: 14/332,671

(22) Filed: Jul. 16, 2014

(30) Foreign Application Priority Data
Jul. 18, 2013 (JP) 2013-149772

(51) Int. Cl. G06K 15/12; H04N 1/50; G06K 15/02

(52) U.S. Cl. CPC G06K 15/129; G06K 15/1822; H04N 1/50; H04N 2201/0094
USPC 358/1.9

(57) ABSTRACT

Disclosed is an image forming apparatus for performing color forming processing which forms a color image on one side or both sides of output paper, or performing monochrome forming processing which forms a monochrome image on one side or both sides of output paper, based on unit image data concerning a page. The image forming apparatus includes: a one-side determination unit for determining whether output data concerning a plurality of sheets are to be image-formed on one side or both sides; a color determination unit for determining whether the unit image data to be image-formed is color image data or monochrome image data based on the determination result by the one-side determination unit; and a forced forming unit for continuously forming images of unit image data concerning a specific number of sheets in the color forming processing based on the determination results by the one-side determination unit and the color determination unit.

### CROSS-REFERENCE TO RELATED APPLICATIONS

This Nonprovisional application claims priority under 35 U.S.C. §119(a) on Patent Application No. 2013-149772 filed in Japan on Jul. 18, 2013, the entire contents of which are hereby incorporated by reference.

### FIELD

The present invention relates to an image forming apparatus for performing color forming processing which forms a color image on one side or both sides of output paper or performing monochrome forming processing which forms a monochrome image on one side or both sides of output paper, based on unit image data concerning a page.

### BACKGROUND

Recently, to cope with a case in which an image of a document is a color image and a case in which an image of a document is a monochrome image, an image forming apparatus having both of a so-called color mode and monochrome mode has been widely distributed.

For example, Japanese Patent Laid-Open Publication No. 2003-237190 discloses a printing system which includes an automatic switching printing mode which automatically switches a full-color printing process and a monochrome printing process depending on a target to be printed and a full-color printing mode which prints all the pages with the full-color printing process and receives any one selection of the printing modes from a user through a printing execution instruction screen.

### SUMMARY

However, in the printing system disclosed in Japanese Patent Laid-Open Publication No. 2003-237190, when the automatic switching printing mode is selected, since the full-color printing process and the monochrome printing process are automatically switched depending on the target to be printed, it takes time to perform the switching, such that there is inconvenience that a user must wait at every switching.

Further, in the printing system disclosed in Japanese Patent Laid-Open Publication No. 2003-237190, when the full-color printing mode is selected, images of all the pages are printed by the full-color printing process irrespective of their attributes (i.e. color image or monochrome image), such that the consumption of a drum, and the like is accelerated.

In consideration of the above-mentioned circumstances, it is an object of the present invention to provide an image forming apparatus for performing color forming processing which forms a color image on one side or both sides of output paper or performing monochrome forming processing which forms a monochrome image on one side or both sides of output paper, based on unit image data concerning a page, in which it is determined whether output data concerning a plurality of sheets are to be image-formed on one side or both sides, it is determined whether the unit image data to be image-formed is color image data or monochrome image data, and images of unit image data concerning a specific number of sheets are continuously formed in the color forming processing based on the determination result, thereby preventing lifespan of the an image forming apparatus from reducing due to continuous printing by the color forming processing while suppressing time consumption due to a frequent change of the color forming processing and the monochrome forming processing as described above.

According to one aspect of the present invention, there is provided an image forming apparatus configured to perform color forming processing which forms a color image on one side or both sides of output paper, or perform monochrome forming processing which forms a monochrome image on one side or both sides of output paper, based on unit image data concerning a page, the image forming apparatus including: a one-side determination unit configured to determine whether output data concerning a plurality of sheets are to be image-formed on one side or both sides; a color determination unit configured to determine whether the unit image data to be image-formed is color image data or monochrome image data based on the determination result by the one-side determination unit; and a forced forming unit configured to continuously form images of unit image data concerning a specific number of sheets in the color forming processing based on the determination results by the one-side determination unit and the color determination unit.

In the image forming apparatus according to the present invention, when the one-side determination unit determines that the output data concerning the plurality of sheets are to be image-formed on the one side, and if the color determination unit determines that the unit image data to be image-formed is the color image data, since then the forced forming unit continuously forms images of the unit image data concerning the specific number of sheets in the color forming processing.

The image forming apparatus according to the present invention may further include: a full monochrome determination unit configured to, after continuous image formation in the color forming processing, determine whether all of the unit image data concerning the specific number of sheets concerning the image formation are the monochrome image data, wherein when the full monochrome determination unit determines that all of the unit image data concerning the specific number of sheets are the monochrome image data, the color determination unit performs the determination for next unit image data to be subsequently image-formed and an image is formed based on the determination result.

The image forming apparatus according to the present invention may further include: an image forming unit configured to form an image of the next unit image data in the monochrome forming processing when the color determination unit determines that the next unit image data is the monochrome image data, wherein after the next unit image data is image-formed in the monochrome forming processing, the color determination unit performs the determination for unit image data to be subsequently image-formed.

In the image forming apparatus according to the present invention, when the color determination unit determines that the next unit image data is the color image data, since then the forced forming unit continuously forms the images of the unit image data concerning the specific number of sheets in the color forming processing.

In the image forming apparatus according to the present invention, when the one-side determination unit determines that the output data concerning the plurality of sheets are to be image-formed on the both sides, and if the color determination unit determines that any one of unit image data concerning one sheet is the color image data, since then the forced forming unit continuously forms images concerning the specific number of sheets in the color forming processing.

The image forming apparatus according to the present invention may further include: a full monochrome determination unit configured to, after continuous image-formation in the color forming processing, determine whether all of the unit image data concerning the specific number of sheets concerning the image formation are the monochrome image data, wherein when the full monochrome determination unit determines that all of the unit image data concerning the specific number of sheets are the monochrome image data, the color determination unit performs the determination for unit image data concerning the next one sheet to be subsequently image-formed and an image is formed based on the determination result.

The image forming apparatus according to the present invention may further include: an image forming unit configured to form an image of the unit image data concerning the next one sheet in the monochrome forming processing when the color determination unit determines that all of the unit image data concerning the next one sheet are the monochrome image data, wherein after the unit image data concerning the next one sheet are image-formed in the monochrome forming processing, the color determination unit performs the determination for the unit image data concerning the one sheet to be subsequently image-formed.

In the image forming apparatus according to the present invention, when the color determination unit determines that any one of the unit image data concerning the next one sheet is the color image data, since then the forced forming unit continuously forms the images of the unit image data concerning the specific number of sheets in the color forming processing.

The image forming apparatus according to the present invention may further include: an input receiving unit configured to receive an input of the specific number of sheets; and a changing unit configured to change the specific number of sheets depending on the input of the specific number of sheets received by the input receiving unit.

According to the present invention, by continuous image-formation of unit image data concerning a specific number of sheets in the color forming processing, it is possible to prevent lifespan of the image forming apparatus from reducing due to continuous printing by the color forming processing while suppress time consumption due to a frequent change of the color forming processing and the monochrome forming processing.

The above and further objects and features will more fully be apparent from the following detailed description with accompanying drawings.

### BRIEF DESCRIPTION OF THE DRAWINGS

FIG. 1 is a perspective view illustrating an example of a printing apparatus according to an embodiment of the present invention;

FIG. 2 is a functional block diagram illustrating a configuration of main parts of the printing apparatus according to the embodiment of the present invention;

FIG. 3 is a longitudinal cross-sectional view illustrating an image forming unit of the printing apparatus according to the embodiment of the present invention;

FIG. 4 is a functional block diagram illustrating a configuration of main parts of a control unit of the printing apparatus according to the embodiment of the present invention;

FIG. 5 is a flow chart for explaining image forming processing in the printing apparatus according to the embodiment of the present invention; and

FIG. 6 is a flow chart for explaining the image forming processing in the printing apparatus according to the embodiment of the present invention.

### DETAILED DESCRIPTION OF NON-LIMITING EXAMPLE EMBODIMENTS

Hereinafter, a case in which an image forming apparatus according to an embodiment of the present invention is applied to a printing apparatus will be described in detail, by way of an example, with reference to the accompanying drawings.

### Embodiment 1

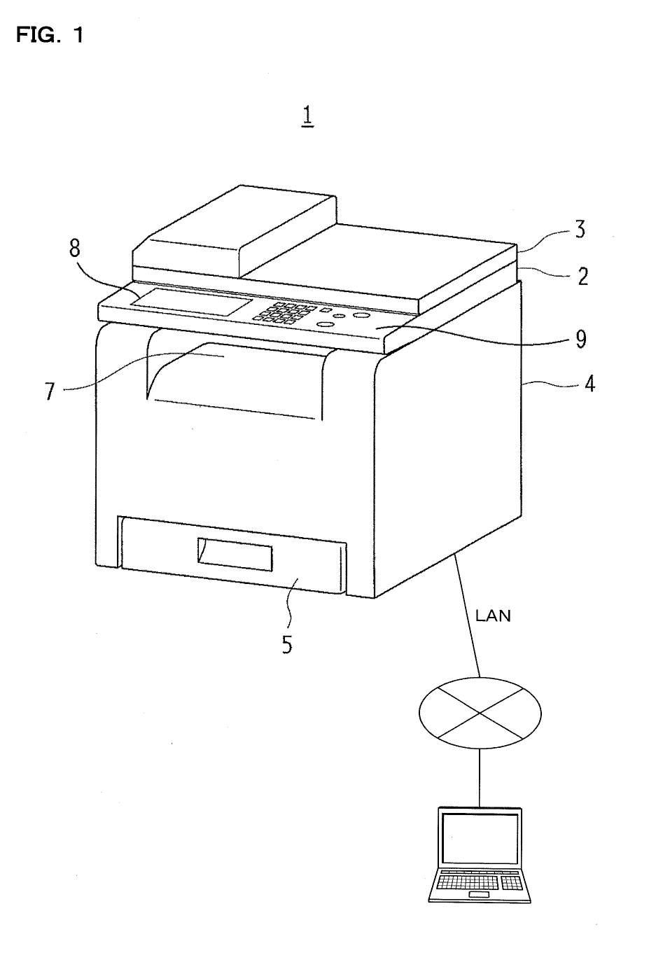

FIG. 1 is a perspective view illustrating an example of a printing apparatus according to Embodiment 1 of the present invention. A printing apparatus 1 according to Embodiment 1 of the present invention serves to perform printing on recording paper based on an image data of a document received through, for example, a LAN. The printing apparatus 1 includes an image reading unit 2, an automatic document feeder (ADF) 3, an image forming unit 4, a paper feeding cassette 5, a paper discharge tray 7 and the like.

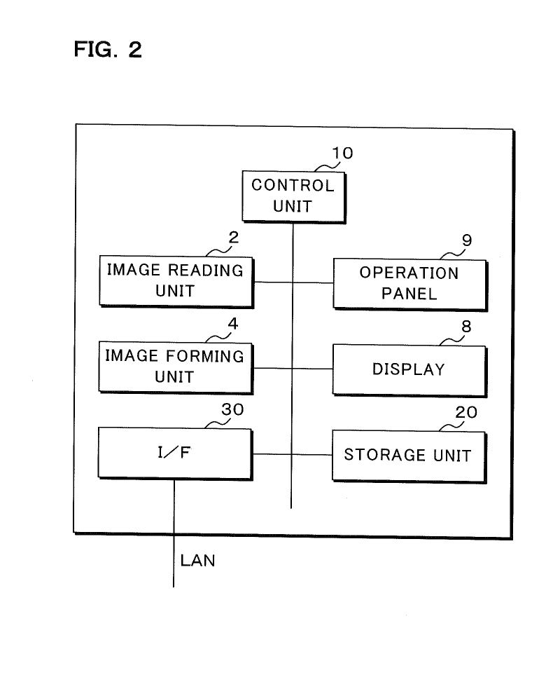

FIG. 2 is a functional block diagram illustrating a configuration of main parts of the printing apparatus 1 according to Embodiment 1 of the present invention. The printing apparatus 1 includes a control unit 10, a storage unit 20, a display unit 8, an operation panel 9, and an I/F 30, in addition to the image reading unit 2 and the image forming unit 4.

The image forming unit 4 generates digital type image data based on an analog data input from the image reading unit 2, performs processing depending on a kind of respective images, and then generates image data to be printed.

Further, the image forming unit 4 acquires output data composed of unit image data concerning a page from an external apparatus through the I/F 30 to form an image based on the acquired image data.

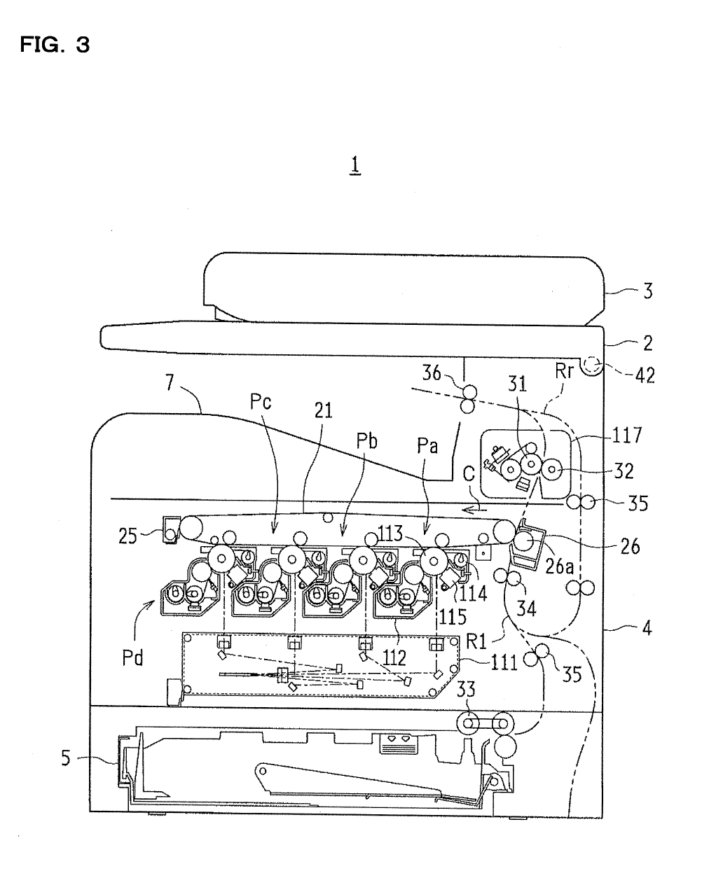

FIG. 3 is a longitudinal cross-sectional view illustrating the image forming unit 4 of the printing apparatus 1 according to Embodiment 1 of the present invention. The image forming unit 4 includes four developing apparatuses 112, four photoconductor drums 113, four drum cleaning apparatuses 114, and four chargers 115, respectively, to form four kinds of toner images depending on each color. These apparatuses each configure four image stations Pa, Pb, Pc, and Pd concerning to black, cyan, magenta, and yellow.

Each of the image stations Pa, Pb, Pc, and Pd removes and withdraws a residual toner on a surface of the photoconductor drum 13 by the drum cleaning apparatuses 114, uniformly charges the surface of the photoconductor drum 13 with a predetermined potential by the charger 115, exposes the surface of the photoconductor drum 13 by an optical scanning device 111, forms an electrostatic latent image on the surface of the photoconductor drum 13, develops the electrostatic latent image on the surface of the photoconductor drum 13 by the developing apparatuses 112, and forms a toner image on the surface of the photoconductor drum 13. Therefore, the toner images of each color are formed on the surfaces of each of the photoconductor drums 113.

Consecutively, after the residual toner of the intermediate transfer belt 21 is removed and withdrawn by the belt cleaning apparatus 25 while the intermediate transfer belt 21 rotates and moves in an arrow direction C, the toner images of each color on the surfaces of each of the photoconductor drums 113 are sequentially transferred and superimposed to the intermediate transfer belt 21 to form the color toner image on the intermediate transfer belt 21.

A nip region is formed between the intermediate transfer belt 21 and a transfer roller 26a of a secondary transfer apparatus 26 and the color toner image on the surface of the intermediate transfer belt 21 is transferred on the recording paper while the recording paper conveyed through a paper conveying path R1 is conveyed, with being inserted into the nip region. Further, the recording paper is heated and pressed, with being inserted between a heating roller 31 and a pressing roller 32 of a fixing apparatus 117 to fix the color toner image on the recording paper.

Meanwhile, the recording paper is drawn out from the paper feeding cassette 5 by a pick-up roller 33 and is conveyed through the paper conveying path R1 and carried out to the paper discharge tray 7 through a paper discharge roller 36, via the secondary transfer apparatus 26 or the fixing apparatus 117. The paper conveyance path R1 is provided with a resist roller 34 which upon stopping the recording paper, aligns an edge of the recording paper, and then starts the conveyance of the recording paper, meeting a transfer timing of the color toner image in the nip region between the intermediate transfer belt 21 and the transfer roller 26a, each conveyor roller 35 which facilitates the conveyance of the recording paper, the paper discharge roller 36 and the like.

Further, when printing is performed on a front surface of the recording paper as well as a rear surface thereof, the recording paper is conveyed from the paper discharge roller 36 in an opposite direction of a reverse path Rr to reverse the front and rear surfaces of the recording paper. The recording paper leads again to the resist roller 34 and an image is recorded and fixed on the rear surface of the recording paper similarly to the front surface thereof, and the recording paper is carried out to the paper discharge tray 7.

The image forming unit 4 having the above-described configuration forms the color image depending on the color image using each color of black (K), cyan (C), magenta (M), and yellow (Y) or forms a monochrome image depending on the monochrome image using black.

In a case of forming the color image in the color forming processing, the four image stations Pa, Pb, Pc, and

Pd start, and in a case of forming the monochrome image in the monochrome forming processing, only one image station Pa starts.

The image reading unit 2 has a light source which irradiates light on a document to be read, an image sensor such as a charge coupled device (CCD), and the like, and optically reads the image data of the document. Further, the image reading unit 2 forms a reflected light image from the document placed at a predetermined reading position on the image sensor to output analog RGB (R: red, G: green, and B: blue) data.

The storage unit 20 is composed of non-volatile storage media, such as a flash memory, an EEPROM (registered trademark), an HDD magnetoresistive memory (MRAM), a ferroelectric RAM (FeRAM), OUM or the like. The storage unit 20 stores a specific number of sheets to be described below, the image data of the document read by the image reading unit 2, the output data composed of the unit image data which are acquired from the external apparatus through the I/F 30 and the like.

For example, the display unit 8 composed of an LCD or electroluminescence (EL) panel displays information, such as a state of the printing apparatus 1, a job processing condition, an image of the document read by the image reading unit 2, and an operation content confirmation of the operation panel 9 which need to be informed to a user.

The operation panel 9 includes a function button for switching functions, such as ‘read’, ‘copy’, and ‘printing’, in the printing apparatus 1, a numeric keypad, a start key, a cancel key, an enter key for deciding received instructions and the like.

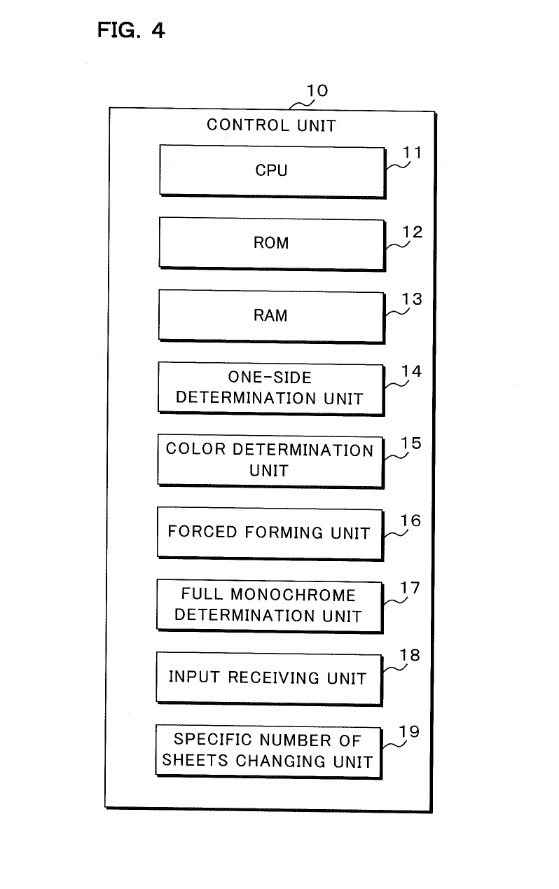

FIG. 4 is a functional block diagram illustrating a configuration of main parts of the control unit 10 in the printing apparatus 1 according to Embodiment 1 of the present invention. The control unit 10 includes a CPU 11, a ROM 12, a RAM 13, a one-side determination unit 14, a color determination unit 15, a forced forming unit 16, a full monochrome determination unit 17, an input receiving unit 18, and a specific number of sheets changing unit 19.

The ROM 12 is previously stored with various control programs, fixed data among parameters for operation, and the like, and the RAM 13 temporarily stores data and may read the data irrespective of a storage order, a storage location and the like. Further, the RAM 13 stores, for example, programs read from the ROM 12, various data generated by running the programs, parameters appropriately changed at the time of the running and the like.

The CPU 11 loads and runs the control programs previously stored in the ROM 12 onto the RAM 13 to control various types of hardware described above and operate the entire apparatus as the printing apparatus 1 of the present invention.

The one-side determination unit 14 determines whether the output data are to be printed on one side (image-formed on one side) or both sides (image-formed on both sides). For example, when the images of the output data composed of the unit image data concerning plurality of sheets are formed, the one-side determination unit 14 determines whether the output data are to be printed on one side or both sides. The determination may be performed, for example, based on the information received from the user through the operation panel 9 and based on metadata such as the number of print copies, printing paper, and the like which are associated with the output data.

The color determination unit 15 determines whether the unit image data to be image-formed is the color image data or the monochrome image data based on the result determined by the one-side determination unit 14. For example, when the one-side determination unit 14 determines that the output data concerning the image formation are to be printed on one side, the color determination unit 15 determines whether the unit image data of the output data acquired from the external apparatus through the I/F 30, or the output data (hereinafter, simply referred to as the acquired output data) which is acquired from the external apparatus through the I/F 30 and stored in the storage unit 20, are the color image data or the monochrome image data.

Meanwhile, when the one-side determination unit 14 determines that the acquired output data concerning the image formation are to be printed on both sides, the color determination unit 15 determines whether any one of unit image data concerning one sheet of the acquired output data is the color image data or all of the unit image data for the one sheet are the monochrome image data. A technique for determining whether the predetermined image data is the color image data or the monochrome image data is well known in the related art, therefore a detailed description thereof will be omitted.

The forced forming unit 16 continuously forms the images of the unit image data concerning the specific number of sheets in the color forming processing based on the determination results by the one-side determination unit 14 and the color determination unit 15. Hereinafter, for convenience of explanation, the specific number of sheets is set to be ‘2’.

For example, when the one-side determination unit 14 determines that the acquired output data concerning the image formation are to be printed on one side, and if the color determination unit 15 determines that the unit image data to be image-formed of the acquired output data are the color image data, since then the forced forming unit 16 continuously forms the images of unit image data concerning two sheets in the color forming processing.

Further, when the one-side determination unit 14 determines that the acquired output data concerning the image formation are to be printed on both sides, and if the color determination unit 15 determines that any one of the unit image data concerning one sheet is the color image data, since then the forced forming unit 16 continuously performs unit image data concerning two sheets in the color forming processing.

When the one-side determination unit 14 determines that the acquired output data concerning the image formation are to be printed on one side, after the continuous image-formation in the color forming processing as described above, the full monochrome determination unit 17 determines whether all of the unit image data from which the image has been formed are the monochrome image data. In addition, even when the one-side determination unit 14 determines that the acquired output data concerning the image formation are to be printed on both sides, after the continuous image-formation in the color forming processing, the full monochrome determination unit 17 determines whether the unit image data of the both sides from which the image has been formed are the monochrome image data.

The input receiving unit 18 receives the input of the specific number of sheets from the user through the operation panel 9. As such, when the input receiving unit 18 receives the input of the specific number of sheets, the specific number of sheets changing unit 19 changes the specific number of sheets previously stored in the storage unit 20 to a specific number of sheets concerning the received input.

In accordance with the printing apparatus 1 according to Embodiment 1 of the present invention having the above-described configuration, when the acquired output data in which the color image data and the monochrome image data are mixed with each other are printed, it is possible to prevent the lifespan of the printing apparatus 1 from reducing, due to the continuous printing in the color forming processing, and it is also possible to suppress the delay of the processing time due to the switching between the color forming processing and the monochrome forming processing.

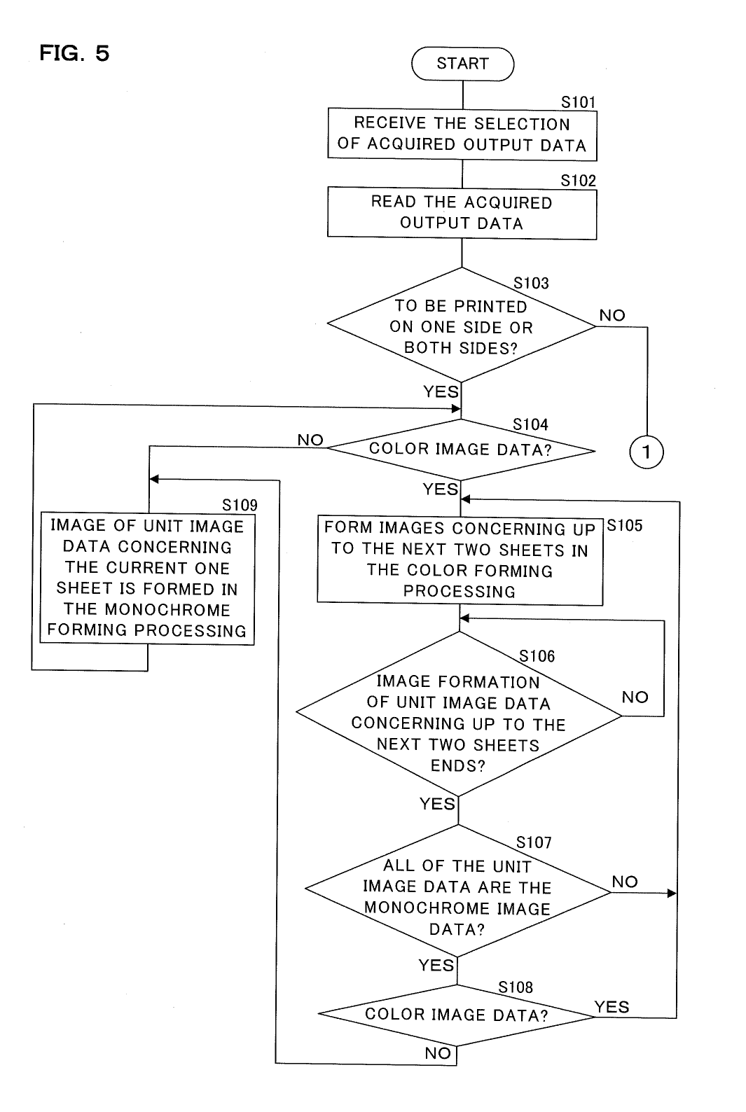

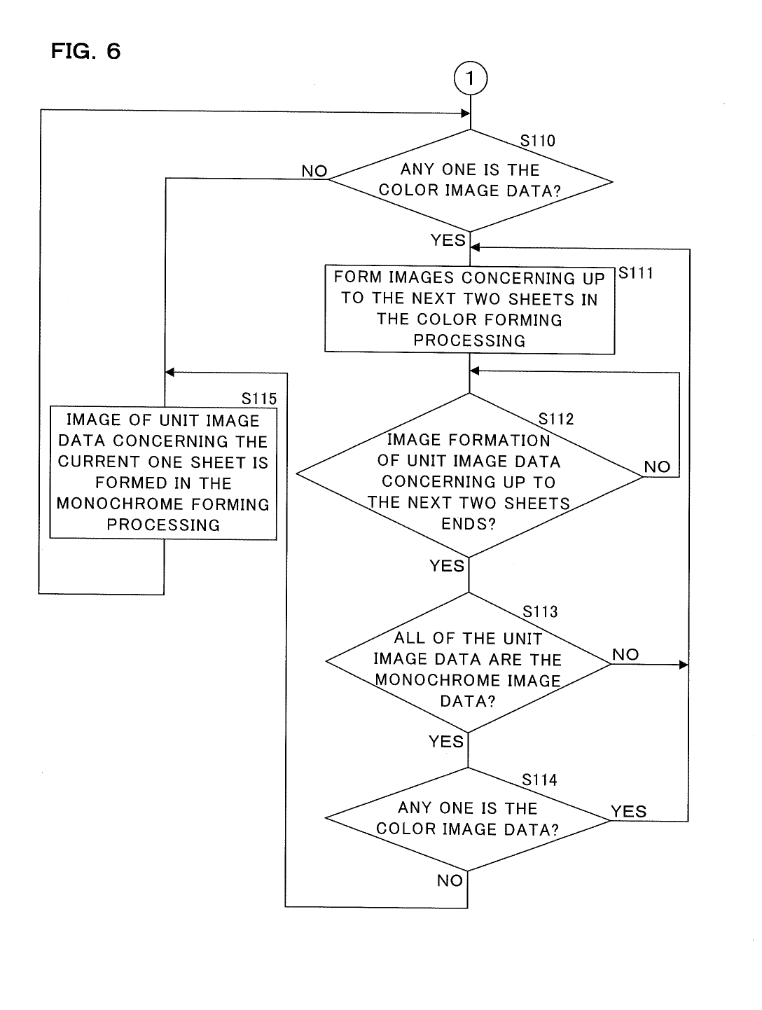

FIGS. 5 and 6 are flow charts for explaining the image forming processing in the printing apparatus 1 according to Embodiment 1 of the present invention. Hereinafter, for convenience of explanation, the case in which the specific number of sheets is set to be ‘2’ and the acquired output data in which the color image data and the monochrome image data are mixed with each other are printed will be described by way of example. Further, the acquired output data are referred to as the output data composed of the unit image data concerning ten sheets of the ‘N’-th, ‘N+1’-th , . . . , ‘N+9’-th.

The user appropriately operates the operation panel 9 while viewing the display unit 8 to appropriately select the acquired output data to be image-formed among the data stored in the storage unit 20. In this case, the CPU 11 receives the selection through the operation panel 9 (step S101).

Next, the CPU 11 reads the acquired output data from the storage unit 20 depending on the received selection (step S102). The acquired output data read is temporarily stored in the RAM 13.

In this case, the one-side determination unit 14 determines whether the acquired output data are to be printed on one side or both sides (step S103). The determination may be performed, for example, based on the information received from the user through the operation panel 9 and the metadata associated with the acquired output data, but according to the present embodiment, is performed based on the information (selection received in step S101) received from the user.

When the one-side determination unit 14 determines that the acquired output data are to be printed on one side (YES in step S103), the color determination unit 15 determines whether unit image data of the ‘N’-th sheet is the color image data, that is, is the color image data or the monochrome image data (step S104).

When the color determination unit 15 determines that unit image data of the ‘N’-th sheet are not the color image data, that is, are the monochrome image data (NO in step S104), the CPU 11 instructs the image forming unit 4 to form a image concerning only the current one sheet, that is, only the unit image data of the ‘N’-th sheet in the monochrome forming processing.

According to the instruction of the CPU 11, the image forming unit 4 forms the image of the unit image data concerning the current one sheet (only the unit image data of the ‘N’-th sheet) on the predetermined recording paper in the monochrome forming processing as described above (step S109).

As such, when the image formation in the monochrome forming processing of only the unit image data of the ‘N’-th sheet ends, the processing returns to step S104.

Consequently, the color determination unit 15 determines whether unit image data concerning the ‘N +1’-th sheet is the color image data, that is, is the color image data or the monochrome image data.

Meanwhile, when the color determination unit 15 determines that the unit image data of the ‘N’-th sheet is the color image data (YES in step S104), the forced forming unit 16 continuously forms the images of the document up to the next two sheets including the unit image data concerning the current ‘N’-th sheet in the color forming processing (step S105).

That is, for example, images of unit image data of the ‘N’-th sheet, ‘N+1’-th sheet, and ‘N+2’-th sheet are continuously formed in the color forming processing irrespective of whether the unit image data of the ‘N+1’-th sheet or ‘N+2’-th sheet is the color image data or the monochrome image data. The forced forming unit 16 issues an appropriate instruction to the image forming unit 4 to form the image.

For example, when the unit image data of the ‘N+1’-th sheet and ‘N+2’-th sheet are the monochrome image data, a so-called dummy data for cyan, magenta, and yellow are generated to form the images in the color forming processing.

In this case, the CPU 11 monitors the image forming unit 4 to determine whether the image formation of the unit image data concerning up to the next two sheets including the ‘N’-th sheet ends (step S106). When it is determined that the image formation of the unit image data concerning the next two sheets including the ‘N’-th sheet does not end (NO in step S106), the CPU 11 repeats the determination until the image formation ends.

Further, when the CPU 11 determines that the image formation of the unit image data concerning the next two sheets including the ‘N’-th sheet ends (YES in step S106), the full monochrome determination unit 17 determines whether the unit image data, from which the images have been continuously formed in the color forming processing as described above, that is, all of the unit image data of the ‘N+1’-th sheet and ‘N+2’-th sheet, are the monochrome image data (step S107). The determination is performed based on the acquired output data stored in the storage unit 20 (RAM 13) or the metadata associated with the acquired output data.

When the full monochrome determination unit 17 determines that all of the unit image data, from which the image has been formed (unit image data concerning the ‘N+1’-th and ‘N+2’-th sheet) in the continuous color forming processing, are not the monochrome image data (NO in step S107), that is, color image data is included, the processing again returns to step S105 and the forced forming unit 16 continuously forms images of unit image data concerning up to the next two sheets in the color forming processing. That is, the image forming unit 4 continuously forms the images of unit image data up to the ‘N+3’-th sheet and ‘N+4’-th sheet.

Meanwhile, when the full monochrome determination unit 17 determines that all of the unit image data, from which the image has been formed (unit image data of the ‘N+1’-th and ‘N+2’-th sheet) in the continuous color forming processing, are the monochrome image data (YES in step S107), the color determination unit 15 again determines that unit image data to be image-formed next is the color image data, that is, unit image data of an ‘N+3’-th sheet is the color image data or the monochrome image data (step S108).

That is, when all of the unit image data, from which the images have been continuously formed in the color forming processing, are the monochrome image data, the possibility that a succeeding unit image data is the monochrome image data is high, such that the color determination unit 15 again determines whether the unit image data to be image-formed next is the color image data and an image is formed based on the determination result.

When the color determination unit 15 determines that the unit image data (unit image data of the ‘N+3’-th sheet) to be image-formed is the color image data (YES in step S108), the processing again returns to step S105 and the forced forming unit 16 continuously forms images of the unit image data concerning up to the next two sheets including the current ‘N+3’-th sheet in the color forming processing. That is, the image forming unit 4 continuously forms images of unit image data up to the ‘N+3’-th sheet, ‘N+4’-th sheet, and ‘N+5’-th sheet in the color forming processing.

When the color determination unit 15 determines that the unit image data (unit image data of the ‘N+3’-th sheet) to be image-formed is not the color image data, that is, is the monochrome image data (NO in step S108), the processing returns to step S109 and the image forming unit 4 forms the image of the unit image data concerning the current one sheet (only the unit image data of the ‘N+3’-th sheet) on the predetermined recording paper in the monochrome forming processing as described above.

Meanwhile, when the one-side determination unit 14 determines that the acquired output data are not to be printed on one side in step S103, that is, to be printed on both sides (NO in step S103), the color determination unit 15 determines whether any one of the unit image data of the ‘N’-th sheet concerning both sides is the color image data, that is, all of the unit image data of the ‘N’-th sheet concerning both sides thereof are the monochrome image data (step S110). (Hereinafter, for convenience of explanation, the unit image data of the ‘N’-th sheet concerning both sides is simply referred to as the unit image data of the ‘N’-th sheet)

When the color determination unit 15 determines that all of the unit image data of the ‘N’-th sheet are not the color image data, that is, all of the unit image data of the ‘N’-th sheet are the monochrome image data (NO in step S110), the CPU 11 instructs the image forming unit 4 to form images concerning only the current one sheet, that is, only the unit image data of the ‘N’-th sheet in the monochrome forming processing.

According to the instruction of the CPU 11, the image forming unit 4 forms the images of the unit image data concerning the current one sheet (only the unit image data of the ‘N’-th sheet) on the predetermined recording paper in the monochrome forming processing as described above (step S115).

As such, when the image formation in the monochrome forming processing of only the unit image data of the ‘N’-th sheet ends, the processing again returns to step S110. Subsequently, the color determination unit 15 determines whether any one of the unit image data of the ‘N+1’-th sheet is the color image data, that is, all of the unit image data concerning the ‘N+1’-th sheet are the monochrome image data.

Meanwhile, when the color determination unit 15 determines that any one of the unit image data of the ‘N’-th sheet is the color image data (YES in step S110), the forced forming unit 16 continuously forms images of unit image data concerning up to the next two sheets including the current ‘N’-th sheet in the color forming processing (step S111).

That is, for example, the images of the unit image data of the ‘N’-th, the ‘N+1’-th sheet and ‘N+2’-th sheet are continuously formed in the color forming processing irrespective of whether any of the unit image data for the ‘N+1’-th sheet and ‘N+2’-th sheet is the color image data or both thereof are the monochrome image data. The forced forming unit 16 issues an appropriate instruction to the image forming unit 4 to form the image.

In this case, the CPU 11 monitors the image forming unit 4 to determine whether the image formation of the unit image data concerning up to the next two sheets including the ‘N’-th sheet ends (step S112). When it is determined that the image formation of the unit image data concerning up to the next two sheets including the ‘N’-th sheet does not end (NO in step S112), the CPU 11 repeats the determination until the image formation ends.

Further, when the CPU 11 determines that the image formation of the unit image data concerning up to the next two sheets including the ‘N’-th sheet ends (YES in step S112), the full monochrome determination unit 17 determines whether the unit image data, from which the images have been continuously formed in the color forming processing as described above, that is, all of the unit image data of the ‘N+1’-th sheet and ‘N+2’-th sheet, are the monochrome image data (step S113). The determination is performed based on the acquired output data stored in the storage unit 20 (RAM 13) or the metadata associated with the acquired output data.

When the full monochrome determination unit 17 determines that all of the unit image data, from which the images have been continuously formed (unit image data concerning the ‘N+1’-th and ‘N+2’-th sheets) in the color forming processing, are not the monochrome image data (NO in step S113), that is, color image data is included, the processing again returns to step S111 and the forced forming unit 16 continuously forms images of unit image data concerning up to the next two sheets in the color forming processing. That is, the image forming unit 4 forms the images of unit image data concerning up to the ‘N+3’-th sheet and ‘N+4’-th sheet in the continuous color forming processing.

Meanwhile, when the full monochrome determination unit 17 determines that all of the unit image data, from which the images have been continuously formed (unit image data concerning the ‘N+1’-th and ‘N+2’-th sheet) in the color forming processing, are the monochrome image data (YES in step S113), the color determination unit 15 again determines that any one of unit image data for one sheet to be image-formed next is the color image data, that is, all of unit image data of the ‘N+3’-th sheet is the monochrome image data (step S114).

That is, when all of the unit image data, from which the images have been continuously formed in the color forming processing, are the monochrome image data, the possibility that unit image data to be subsequently image-formed is the monochrome image data is high, such that the color determination unit 15 determines whether any one of the unit image data for one sheet to be image-formed next is the color image data and an image is formed based on the determination result.

When the color determination unit 15 determines that the unit image data concerning one sheet (unit image data of the ‘N+3’-th sheet) to be image-formed is the color image data (YES in step S114), the processing again returns to step S111 and the forced forming unit 16 continuously forms images of unit image data concerning up to the next two sheets including the current ‘N+3’-th sheet in the color forming processing. That is, the image forming unit 4 continuously forms images of unit image data concerning up to the ‘N+3’-th sheet, ‘N+4’-th sheet, and ‘N+5’-th sheet in the color forming processing.

When the color determination unit 15 determines that all of the unit image data concerning one sheet (unit image data for the ‘N+3’-th sheet) to be image-formed are not the color image data, that is, are the monochrome image data (NO in step S114), the processing returns to step S115 and the image forming unit 4 forms the image of the unit image data for current one sheet (only unit image data for the ‘N+3’-th sheet) on the predetermined recording paper in the monochrome forming processing as described above.

At the time of performing the processing as described above, if the image forming unit 4 monitors the image formation to determine that the image formation of the acquired output data for the entire sheets ends, the CPU 11 generates a signal to end the processing as an interrupt signal.

Further, the one-side determination unit 14, the color determination unit 15, the forced forming unit 16, the full monochrome determination unit 17, the input receiving unit 18, and the specific number of sheets changing unit 19 which are described above may be constructed in a hardware logic type manner and may be constructed in a software type manner as the CPU 11 runs a predetermined program.

### Embodiment 2

The present invention is not limited to the above description. The printing apparatus 1 according to Embodiment 2 of the present invention is configured to change the specific number of sheets. That is, the user appropriately operates the operation panel 9 and may input the specific number of sheets. In this case, when the input receiving unit 18 receives the input of the specific number of sheets from the user through the operation panel 9, the specific number of sheets changing unit 19 changes a specific number of sheets previously stored in the storage unit 20 to the specific number of sheets concerning the received input.

For example, when the user thinks a functions is important (for example, printing speed) in the image forming of the printing apparatus 1, the specific number of sheets is set to be large, such that the switching between the color forming processing and the monochrome forming processing is suppressed and the image formation speed increase.

Meanwhile, when the user thinks the lifespan of the apparatus is important in the printing apparatus 1 according to the embodiment of the present invention, the specific number of sheets is set to be small, such that the execution in the color forming processing is suppressed and thus the wasteful use of the image stations Pb, PC, and Pd concerning colors is prevented, and the lifespan of the printing apparatus 1 increase.

### Embodiment 3

Embodiment 1 describes the example that the printing process of the output data acquired from the external apparatus through the I/F 30 or the output data which are acquired from the external apparatus through the I/F 30 and stored in the storage unit 20 are printed, but the present invention is not limited thereto.

For example, the present invention may be applied even to the case in which a bundle of documents in which color images and monochrome images are mixed with each other is placed on a document feeding apparatus 3 and the copy of the bundle of documents may be performed.

According to the present invention, there is provided an image forming apparatus configured to perform color forming processing which forms a color image on one side or both sides of output paper, or perform monochrome forming processing which forms a monochrome image on one side or both sides of output paper, based on unit image data concerning a page, the image forming apparatus characterized by including: a one-side determination unit configured to determine whether output data concerning a plurality of sheets are to be image-formed on one side or both sides; a color determination unit configured to determine whether the unit image data to be image-formed is color image data or monochrome image data based on the determination result by the one-side determination unit; and a forced forming unit configured to continuously form images of unit image data concerning a specific number of sheets in the color forming processing based on the determination results by the one-side determination unit and the color determination unit.

According to the present invention, the forced forming unit continuously forms the images of the unit image data for only the specific number of sheets in the color forming processing, based on the determination results by the one-side determination unit and the color determination unit.

The image forming apparatus according to the present invention is characterized in that, when the one-side determination unit determines that the output data concerning the plurality of sheets are to be image-formed on the one side, and if the color determination unit determines that the unit image data to be image-formed is the color image data, since then the forced forming unit continuously forms images of the unit image data concerning the specific number of sheets in the color forming processing.

According to the present invention, when the one-side determination unit determines that the predetermined output data are to be image-formed on the one side and the color determination unit determines that the unit image data are the color image data, the forced forming unit continuously forms the images of the unit image data and the images of unit image data for the specific number of sheets after the unit image data in the color forming processing.

The image forming apparatus according to the present invention is characterized by further including: a full monochrome determination unit configured to, after continuous image formation in the color forming processing, determine whether all of the unit image data concerning the specific number of sheets concerning the image formation are the monochrome image data, wherein when the full monochrome determination unit determines that all of the unit image data concerning the specific number of sheets are the monochrome image data, the color determination unit performs the determination for next unit image data to be subsequently image-formed and an image is formed based on the determination result.

According to the present invention, when the full monochrome determination unit determines that all of the unit image data concerning the image formation of the continuous color forming processing are the monochrome image data, the color determination unit determines whether the images of the document (next unit image data) to be subsequently image-formed are the color image data or the monochrome image data and forms the next image based on the determination result.

The image forming apparatus according to the present invention is characterized by further including: an image forming unit configured to form an image of the next unit image data in the monochrome forming processing when the color determination unit determines that the next unit image data is the monochrome image data, wherein after the next unit image data is image-formed in the monochrome forming processing, the color determination unit performs the determination for unit image data to be subsequently image-formed.

According to the present invention, when the color determination unit determines that the next unit image data is the monochrome image data, the image of the next unit image data is formed in the monochrome forming processing and after the image is formed, the color determination unit determines whether the unit image data to be subsequently image-formed are the color image data or the monochrome image data.

The image forming apparatus according to the present invention is characterized in that, when the color determination unit determines that the next unit image data is the color image data, since then the forced forming unit continuously forms the images of the unit image data concerning the specific number of sheets in the color forming processing.

According to the present invention, when the color determination unit determines that the next unit image data of the document are the color image data, since then the forced forming unit continuously forms the images of unit image data for the specific number of sheets in the color forming processing.

The image forming apparatus according to the present invention is characterized in that, when the one-side determination unit determines that the output data concerning the plurality of sheets are to be image-formed on the both sides, and if the color determination unit determines that any one of unit image data concerning one sheet is the color image data, since then the forced forming unit continuously forms images concerning the specific number of sheets in the color forming processing.

According to the present invention, when the one-side determination unit determines that the predetermined output data are to be image-formed on the one side and the color determination unit determines that any one of the unit image data for one sheet is the color image data, the forced forming unit continuously forms the images of the unit image data for one sheet and unit image data for the specific number of sheets after the unit image data in the color forming processing.

The image forming apparatus according to the present invention is characterized by further including: a full monochrome determination unit configured to, after the continuous image-formation in the color forming processing, determine whether all of the unit image data concerning the specific number of sheets concerning the image formation are the monochrome image data, wherein when the full monochrome determination unit determines that all of the unit image data concerning the specific number of sheets are the monochrome image data, the color determination unit performs the determination for unit image data concerning the next one sheet to be subsequently image-formed and an image is formed based on the determination result.

According to the present invention, when the full monochrome determination unit determines that all of the unit image data concerning the image formation of the continuous color forming processing are the monochrome image data, the color determination unit determines whether any one of the unit image data for one sheet (the unit image data concerning the next one sheet) to be subsequently image-formed is the color image data and forms the next image based on the determination result.

The image forming apparatus according to the present invention is characterized by further including: an image forming unit configured to form images of the unit image data concerning the next one sheet in the monochrome forming processing when the color determination unit determines that all of the unit image data concerning the next one sheet are the monochrome image data, wherein after the unit image data concerning the next one sheet are image-formed in the monochrome forming processing, the color determination unit performs the determination for unit image data concerning the one sheet to be subsequently image-formed.

According to the present invention, when the color determination unit determines that all of the unit image data concerning the next one sheet are the monochrome image data, the images of the unit image data concerning the next one sheet are formed in the monochrome forming processing and after the images are formed, the color determination unit performs the determination for the unit image data for one sheet to be subsequently image-formed.

The image forming apparatus according to the present invention is characterized in that, when the color determination unit determines that any one of the unit image data concerning the next one sheet is the color image data, since then the forced forming unit continuously forms the images of the unit image data concerning the specific number of sheets in the color forming processing.

According to the present invention, when the color determination unit determines that any of the unit image data concerning the next one sheet is the color image data, since then the forced forming unit continuously forms the images of unit image data for the specific number of sheets in the color forming processing.

The image forming apparatus according to the present invention is characterized by further including: an input receiving unit configured to receive an input of the specific number of sheets; and a changing unit configured to change the specific number of sheets depending on the input of the specific number of sheets received by the input receiving unit.

According to the present invention, when the input receiving unit receives the input of the specific number of sheets, the changing unit changes the specific number of sheets depending on the input of the specific number of sheets received by the input receiving unit.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. An image forming apparatus configured to perform color forming processing which forms a color image on one side or both sides of output paper, or perform monochrome forming processing which forms a monochrome image on one side or both sides of output paper, based on unit image data concerning a page, the image forming apparatus comprising:
a one-side determination unit configured to determine whether output data concerning a plurality of sheets are to be image-formed on one side or both sides;
a color determination unit configured to determine whether the unit image data to be image-formed is color image data or monochrome image data based on the determination result by the one-side determination unit; and
a forced forming unit configured to continuously form images of unit image data concerning a specific number of sheets in the color forming processing based on the determination results by the one-side determination unit and the color determination unit.

2. The image forming apparatus according to claim 1, wherein when the one-side determination unit determines that the output data concerning the plurality of sheets are to be image-formed on the one side, and if the color determination unit determines that the unit image data to be image-formed is the color image data, since then the forced forming unit continuously forms images of the unit image data concerning the specific number of sheets in the color forming processing.

3. The image forming apparatus according to claim 2, further comprising:
a full monochrome determination unit configured to, after continuous image formation in the color forming processing, determine whether all of the unit image data concerning the specific number of sheets concerning the image formation are the monochrome image data,
wherein when the full monochrome determination unit determines that all of the unit image data concerning the specific number of sheets are the monochrome image data, the color determination unit performs the determination for next unit image data to be subsequently image-formed and an image is formed based on the determination result.

4. The image forming apparatus according to claim 3, further comprising:
an image forming unit configured to form an image of the next unit image data in the monochrome forming processing when the color determination unit determines that the next unit image data is the monochrome image data,
wherein after the next unit image data is image-formed in the monochrome forming processing, the color determination unit performs the determination for unit image data to be subsequently image-formed.

5. The image forming apparatus according to claim 3, wherein when the color determination unit determines that the next unit image data is the color image data, since then the forced forming unit continuously forms the images of the unit image data concerning the specific number of sheets in the color forming processing.

6. The image forming apparatus according to claim 1, wherein when the one-side determination unit determines that the output data concerning the plurality of sheets are to be image-formed on the both sides, and if the color determination unit determines that any one of unit image data concerning one sheet is the color image data, since then the forced forming unit continuously forms images concerning the specific number of sheets in the color forming processing.

7. The image forming apparatus according to claim 6, further comprising:
a full monochrome determination unit configured to, after continuous image-formation in the color forming processing, determine whether all of the unit image data concerning the specific number of sheets concerning the image formation are the monochrome image data,
wherein when the full monochrome determination unit determines that all of the unit image data concerning the specific number of sheets are the monochrome image data, the color determination unit performs the determination for unit image data concerning the next one sheet to be subsequently image-formed and an image is formed based on the determination result.

8. The image forming apparatus according to claim 7, further comprising:
an image forming unit configured to form images of the unit image data concerning the next one sheet in the monochrome forming processing when the color determination unit determines that all of the unit image data concerning the next one sheet are the monochrome image data,
wherein after the unit image data concerning the next one sheet are image-formed in the monochrome forming processing, the color determination unit performs the determination for unit image data concerning the one sheet to be subsequently image-formed.

9. The image forming apparatus according to claim 7, wherein when the color determination unit determines that any one of the unit image data concerning the next one sheet is the color image data, since then the forced forming unit continuously forms images of the unit image data concerning the specific number of sheets in the color forming processing.

10. The image forming apparatus according to claim 1, further comprising:
an input receiving unit configured to receive an input of the specific number of sheets; and
a changing unit configured to change the specific number of sheets depending on the input of the specific number of sheets received by the input receiving unit.

11. An image forming method in an image forming apparatus configured to perform color forming processing which forms a color image on one side or both sides of output paper, or perform monochrome forming processing which forms a monochrome image on one side or both sides of output paper, based on unit image data concerning a page, the image forming method comprising:
a one-side determining step of determining whether output data concerning a plurality of sheets are to be image-formed on one side or both sides;
a color determining step of determining whether the unit image data to be image-formed is color image data or monochrome image data based on the determination result in the one-side determining step; and
a forced forming step in which, when it is determined in the one-side determining step that the output data concerning the plurality of sheets are to be image-formed on the one side, and if it is determined in the color determining step that the unit image data to be image-formed is the color image data, since then images of the unit image data concerning a specific number of sheets are continuously formed in the color forming processing.

12. An image forming method in an image forming apparatus configured to perform color forming processing which forms a color image on one side or both sides of output paper, or perform monochrome forming processing which forms a monochrome image on one side or both sides of output paper, based on unit image data concerning a page, the image forming method comprising:
a one-side determining step of determining whether output data concerning a plurality of sheets are to be image-formed on one side or both sides;
a color determining step of determining whether the unit image data to be image-formed is color image data or monochrome image data based on the determination result in the one-side determining step; and
a forced forming step in which, when it is determined in the one-side determining step that the output data concerning the plurality of sheets are to be image-formed on the both sides, and if it is determined in the color determining step that any one of unit image data concerning one sheet is the color image data, since then images of the unit image data concerning a specific number of sheets are continuously formed in the color forming processing.
